(19) United States
(12) Patent Application Publication
(10) Pub. No.: US 2024/0047831 A1
(43) Pub. Date: Feb. 8, 2024

(54) BATTERY-CONNECTED CIRCUIT BOARD, BATTERY ASSEMBLY, ELECTRONIC DEVICE

(71) Applicant: VIVO MOBILE COMMUNICATION CO., LTD., Dongguan (CN)

(72) Inventors: Diankai WANG, Dongguan (CN); Zhiliang GUO, Dongguan (CN)

(73) Assignee: VIVO MOBILE COMMUNICATION CO., LTD., Dongguan (CN)

(21) Appl. No.: 18/381,613

(22) Filed: Oct. 18, 2023

Related U.S. Application Data
(63) Continuation of application No. PCT/CN2022/086563, filed on Apr. 13, 2022.

(30) Foreign Application Priority Data
Apr. 20, 2021 (CN) 202110426035.1

(51) Int. Cl. H01M 50/50; H01M 10/42; H01M 10/46

(52) U.S. Cl. CPC H01M 50/50; H01M 10/425; H01M 10/46

(57) ABSTRACT

A battery-connected circuit board, a battery assembly, and an electronic device are provided. The battery-connected circuit board includes a substrate. The substrate is an insulator, and the substrate includes a first area part and a second area part. First conductive layers are disposed on surfaces on both sides of the first area part. A second conductive layer is disposed on a surface on one side of the second area part. The second conductive layer is electrically connected to one of the first conductive layers that is on a same side as the second conductive layer.

### CROSS-REFERENCE TO RELATED APPLICATIONS

This application is a continuation of International Application No. PCT/CN2022/086563, filed Apr. 13, 2022, which claims priority to Chinese Patent Application No. 202110426035.1, filed Apr. 20, 2021. The entire contents of each of the above-referenced applications are expressly incorporated herein by reference.

### TECHNICAL FIELD

This application relates to the field of terminal technologies, and in particular to a battery-connected circuit board, a battery assembly, and an electronic device.

### BACKGROUND

An existing circuit board has a thickness. When the circuit board matches a battery, a thickness of a device is increased, which does not facilitate an increase of a battery capacity and reduction of an entire thickness of the device.

### SUMMARY

Embodiments of this application are intended to provide a battery-connected circuit board, a battery assembly, and an electronic device.

According to a first aspect, an embodiment of this application provides a battery-connected board. The battery-connected board includes:
a substrate, where the substrate is an insulator, the substrate includes a first area part and a second area part, first conductive layers are disposed on surfaces on both sides of the first area part, a second conductive layer is disposed on a surface on one side of the second area part, and the second conductive layer is electrically connected to a first conductive layer, on a same side, of the first conductive layers.

A first cover film is disposed on one side, away from the substrate, of the first conductive layer. A second cover film is disposed on one side, away from the substrate, of the second conductive layer. The first cover film and the second cover film are insulating material films.

The first area part is provided with a through hole. A conductive connector is disposed in the through hole. The conductive connector is separately connected to the first conductive layers on the surfaces on both sides of the first area part.

A first base layer is disposed between the substrate and the first conductive layer, and the first base layer is a conductive material layer.

A second base layer is disposed between the substrate and the second conductive layer, and the second base layer is a conductive material layer.

Materials and/or thicknesses of the first base layer and the second base layer are the same.

Materials and/or thicknesses of the first conductive layer and the second conductive layer are the same;
the first conductive layer and the second conductive layer are metal material layers: or
the battery-connected circuit board is a flexible circuit board.

According to a second aspect, an embodiment of this application provides a battery assembly. The battery assembly includes:
the battery-connected circuit board in the foregoing embodiment; and
a cell structure, where an edge of the cell structure is provided with a sink, a first conductive layer, close to the cell structure, of the first conductive layers is located in the sink, a surface on the other side of the second area part of the substrate abuts against a surface on one side of the cell structure, and first conductive layers on surfaces on both sides of the first area. part are both electrically connected to a charging electrode of the cell structure.

The battery assembly further includes:
a motherboard, where the cell structure is disposed on one side of the motherboard, and the battery-connected circuit board is disposed on one side, away from the motherboard, of the cell structure.

The first conductive layer is electrically connected to the motherboard, and the second conductive layer is electrically connected to the motherboard.

The battery assembly further includes:
a charging board, where the charging board is disposed on the motherboard, the charging board is electrically connected to the motherboard, and the charging board is electrically connected to the charging electrode of the cell structure.

A first connection part and a second connection part are disposed on the motherboard, the cell structure is disposed between the first connection part and the second connection part, the second conductive layer is electrically connected to the first connection part, one end of the charging board is electrically connected to the charging electrode of the cell structure, and the other end of the charging board is electrically connected to the second connection part.

According to a third aspect, an embodiment of this application provides an electronic device. The electronic device includes the battery assembly in the foregoing embodiment.

A battery-connected circuit board according to this embodiment of this application includes: a substrate, where the substrate is an insulator, the substrate includes a first area part and a second area part, first conductive layers are disposed on surfaces on both sides of the first area part, a second conductive layer is disposed on a surface on one side of the second area part, and the second conductive layer is electrically connected to a first conductive layer, on a same side, of the first conductive lavers. In the battery-connected circuit board of this application, the first conductive layers are disposed on surfaces on both sides of the first area part, the second conductive layer is disposed on a surface on one side of the second area part, the second conductive layer is electrically connected to the first conductive layer, on a same side, of the first conductive layers, and no second conductive layer is disposed on a surface on the other side of the second area part. When the circuit board matches a battery, the surface on the other side of the second area part may abut against a surface on one side of the battery, to reduce an overall thickness of the circuit board and the battery. This helps to increase a capacity of the battery, and helps to reduce an overall thickness of the device. A first conductive layer, on one side close to the cell structure, in the first area part is located in the sink, which does not cause an increase of the overall thickness.

### BRIEF DESCRIPTION OF DRAWINGS

FIG. 1 is a schematic diagram of a structure of a battery-connected circuit board according to an embodiment of this application;

FIG. 2 is a schematic diagram of a structure of a battery-connected circuit board according to a comparative embodiment;

FIG. 3 is another schematic diagram of a structure of a battery-connected circuit board according to a comparative embodiment;

FIG. 4 is a schematic diagram of matching between a battery-connected circuit board and a cell structure according to an embodiment of this application;

FIG. 5 is another schematic diagram of matching between the battery-connected circuit board and the cell structure according to an embodiment of this application;

FIG. 6 is another schematic diagram of the structure of the battery-connected circuit board according to an embodiment of this application; and

FIG. 7 is still another schematic diagram of matching between the battery-connected circuit board and the cell structure according to an embodiment of this application.

### DETAILED DESCRIPTION

The following clearly describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first”, “second”, and the like in this specification and claims of this application are used to distinguish between similar objects instead of describing a specific order or sequence. It should be understood that data used in this way may be interchangeable in appropriate cases, so that the embodiments of this application can be implemented in a sequence other than those shown or described herein. In addition, in this specification and the claims, “and/or” represents at least one of connected objects, and a character “/” generally represents an “or” relationship between associated objects.

With reference to FIG. 1 to FIG. 7, a battery-connected circuit board provided in embodiments of this application is described in detail by using embodiments and application scenarios for the embodiments.

FIG. 1 is a battery-connected circuit board according to an embodiment of this application. The battery-connected circuit board includes a substrate 10. The substrate 10 is an insulator. For example, the substrate 10 is a plastic board. The substrate 10 includes a first area part and a second area part. An edge of the first area part may be in direct contact with and connected to an edge of the second area part. First conductive layers 11 are disposed on surfaces on both sides of the first area part, and a second conductive layer 12 is disposed on a surface on one side of the second area part. The second conductive layer 12 is electrically connected to a. first conductive layer 11, on a same side, of the first conductive layers 11. An edge of the second conductive layer 12 may be directly connected to an edge of the first conductive layer 11 on a same side. The first conductive layers 11 on surfaces on both sides of the first area part may be electrically connected.

In the battery-connected circuit board of this application, the first conductive layers 11 are disposed on surfaces on both sides of the first area part of the substrate 10, the second conductive layer 12 is disposed on a surface on one side of the second area part, the second conductive layer 12 is electrically connected to the first conductive layer 11, on a same side, of the first conductive layers 11, and no second conductive layer 12 is disposed on a surface on the other side of the second area part. When the circuit board matches a battery, the surface on the other side of the second area part may abut against a surface on one side of the battery, to reduce an overall thickness of the circuit board and the battery. This helps to increase a capacity of the battery, and helps to reduce an overall thickness of the device. A first conductive layer 11, on one side close to the cell structure, in the first area part is located in the sink, which does not cause an increase of the overall thickness.

As shown in FIG. 1, in some embodiments, a first cover film 13 is disposed on one side, away from the substrate 10, of the first conductive layer 11. The first conductive layer 11 may be protected by using the first cover film 13, to prevent the first conductive layer 11 from being damaged. A second cover film 14 is disposed on one side, away from the substrate 10, of the second conductive layer 12. The first cover film 13 and the second cover film 14 are insulating material films. The second conductive layer 12 may be protected by using the second cover film 14, to prevent the second conductive layer 12 from being damaged. The first cover film 13 may be an insulating resin material, such as polyimide. The first cover film 13 may be bonded to the first conductive layer 11 by using a first adhesive layer 17, and the first adhesive layer 17 may be an acrylic hot melt adhesive. The second cover film 14 may be an insulating resin material, such as polyimide. The second cover film 14 may be bonded to the second conductive layer 12 by using a second adhesive layer 18, and the second adhesive layer 18 may be an acrylic hot melt adhesive.

In some other embodiments, the first area part may be provided with a through hole, and a conductive connector is disposed in the through hole. The conductive connector is separately connected to the first conductive layers 11 on the surfaces on both sides of the first area part, that is, the first conductive layers 11 on the surfaces on both sides of the first area part implements electrical connection by using the conductive connector.

In an embodiment of this application, as shown in FIG. 1, a first base layer 15 may be disposed between the substrate 10 and the first conductive layer 11. The first base layer 15 is a conductive material layer. During preparation, one layer of the first base layer 15 is disposed on a surface of the substrate 10, helping to form the first conductive layer 11. A second base layer 16 may be disposed between the substrate 10 and the second conductive layer 12. The second base layer 16 is a conductive material layer. One layer of the second base layer 16 is disposed on a surface of the substrate 10, helping to form the second conductive layer 12.

Materials and/or thicknesses of the first base layer 15 and the second base layer 16 are the same, helping to form the first base layer 15 and the second base layer 16 on the substrate and simplify a preparation process.

In some embodiments, materials and/or thicknesses of the first conductive layer 11 and the second conductive layer 12 are the same, helping to form the first conductive layer 11 and the second conductive layer 12, and simplify a preparation process.

In some embodiments, the first conductive layer 11 and the second conductive layer 12 may be metal material layers, for example, the first conductive layer 11 and the second conductive layer 12 are both copper layers. The first conductive layer 11 may be protected by using the first cover film 13, to prevent the first conductive layer 11 from being oxidized and damaged by external air. The second conductive layer 12 may be protected by using the second cover film 14, to prevent the second conductive layer 12 from being oxidized and damaged by external air.

In some embodiments, the battery-connected circuit board may be a flexible circuit board, to help to match the circuit board and the battery.

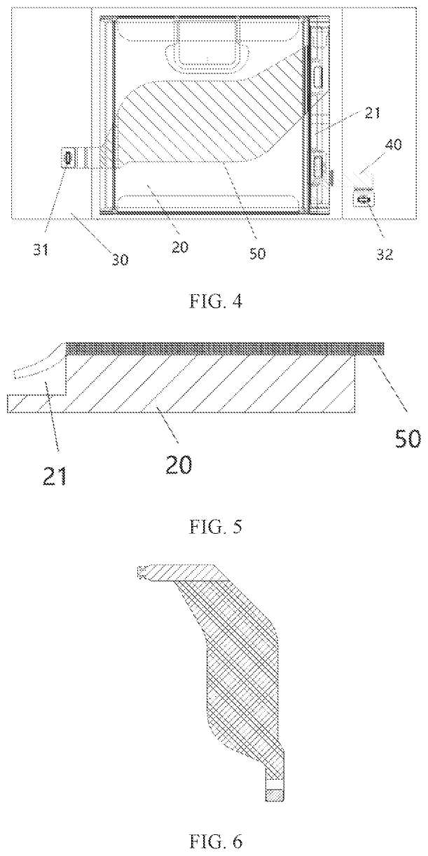

As shown in FIG. 4 to FIG. 7, embodiments of this application provide a battery assembly. The battery assembly includes the battery-connected circuit board 50 and the cell structure 20 in the foregoing embodiment. An edge of the cell structure 20 may be provided with a sink 21. A first conductive layer 11, close to the cell structure 20, of the first conductive layers 11 may be located in the sink 21, without increasing an overall thickness. A surface on the other side of the second area part of the substrate 10 abuts against a surface on one side of the cell structure 20, to reduce an overall thickness of the circuit board and a battery, helping to increase a capacity of the battery, and helping to reduce an overall thickness of a device. The first conductive layers 11 located on surfaces on both sides of the first area part are both electrically connected to a charging electrode of the cell structure 20, and the cell structure 20 may be charged by using the first conductive layer 11. In an entire battery compartment with a fixed thickness, a reduced thickness may be used to increase a thickness of the cell, helping to increase a battery capacity, increase use duration of a mobile phone, and improve user satisfaction.

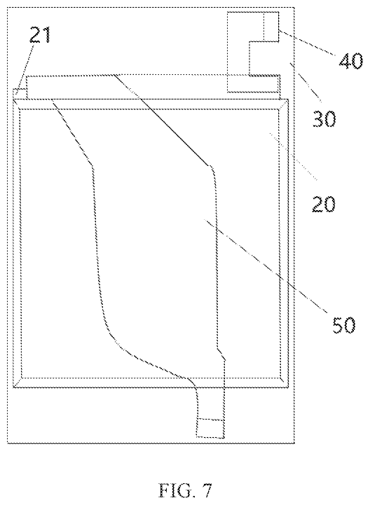

In some embodiments, as shown in FIG. 4 and FIG. 7, the battery assembly further includes a motherboard 30. The cell structure 20 is disposed on one side of the motherboard 30, and the battery-connected circuit board 50 is disposed on one side, away from the motherboard of the cell structure 20. The first conductive layer II may be electrically connected to the motherboard 30. The second conductive layer 12 may be electrically connected to the motherboard 30. A current at the motherboard 30 may be used to charge cell structure 20 through the first conductive layer 11 and the second conductive layer 12.

In some embodiments, as shown in FIG. 4 and FIG. 7, the battery assembly further includes a charging board 40. The charging board 40 is disposed on the motherboard 30, and the charging board 40 may be a flexible circuit board. The charging board 40 is electrically connected to the motherboard 30, and the charging board 40 is electrically connected to the charging electrode of the cell structure 20. The motherboard 30 may further charge the cell structure 20 by using the charging board 40. The motherboard 30 may charge the cell structure through the charging board 40 and the battery-connected circuit board 50 simultaneously, improving charging efficiency and facilitating heat loss.

In an embodiment of this application, as shown in FIG. 4, a first connection part 31 and a second connection part 32 are disposed on the motherboard 30, the cell structure 20 is disposed between the first connection part 31 and the second connection part 32, the second conductive layer 12 is electrically connected to the first connection part 31, one end of the charging board 40 is electrically connected to the charging electrode of the cell structure 20, and the other end of the charging board 40 is electrically connected to the second connection part 32. The first connection part 31 and the second connection part 32 are distributed at two ends of the cell structure 20, and the charging board 40 and the battery-connected circuit board may be separated, facilitating heat loss during charging.

An embodiment of this application provides an electronic device. The electronic device includes the battery assembly in the foregoing embodiment. The electronic device with the battery assembly in the foregoing embodiment helps to reduce a thickness, increase a cell thickness, and increase a battery capacity.

During application of the battery-connected circuit board in this application, when the thickness of the circuit board is greatly reduced, an original impedance effect may remain unchanged.

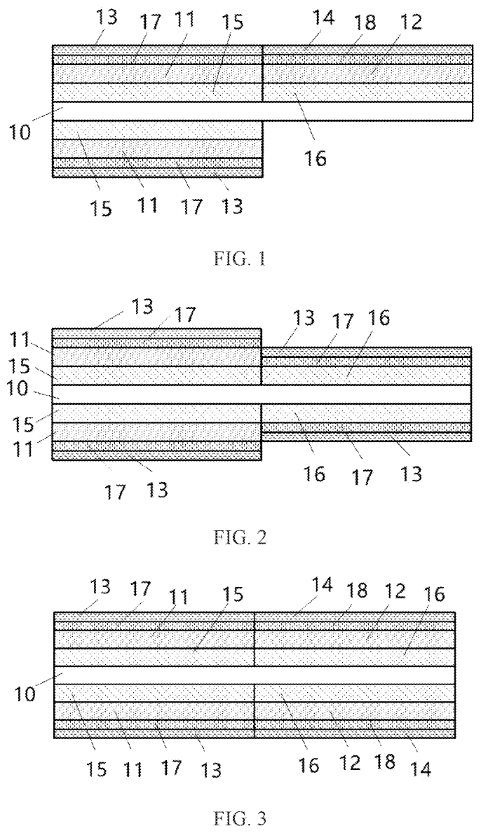

The following further describes this application with reference to some embodiments. As shown in FIG. 1 and FIG. 2, thicknesses of layers in Comparative embodiment 1 and Embodiment 1 are shown in the following Table 1. Both the conductive layer and the base layer are copper layers.

TABLE 1
Thicknesses of layers on the substrate

| Embodiment 1 and | | | Comparative | Embodi- |
|---|---|---|---|---|
| Comparative embodiment 1 | | Name | embodiment 1 | ment 1 |
| | Thickness/ | Second | Thickness/ | Thickness/ |
| First area part | μm | area part | μm | μm |
| First cover film | 12.5 | Second cover | 12.5 | 12.5 |
| | | film | | |
| First adhesive | 25 | Second | 25 | 25 |
| layer | | adhesive layer | | |
| First conductive | 18 | Second | 0 | 18 |
| layer | | conductive | | |
| | | layer | | |
| First base layer | 18 | Second base | 18 | 18 |
| | | layer | | |
| Substrate | 25 | Substrate | 25 | 25 |
| First base layer | 18 | Second base | 18 | 0 |
| | | layer | | |
| First conductive | 18 | Second | 0 | 0 |
| layer | | conductive | | |
| | | layer | | |
| First adhesive | 25 | Second | 25 | 0 |
| layer | | adhesive layer | | |
| First cover film | 12.5 | Second cover | 12.5 | 0 |
| | | film | | |
| Total thickness | 172 | Total thickness | 136 | 98.5 |
| Copper | 72 | Copper | 36 | 36 |
| thickness | | thickness | | |

In the Comparative embodiment 1 and Embodiment 1, a thickness of the substrate remains unchanged, that is, the substrate is still 25 μm, the first base layer is still 18 μm, and a thickness of the first conductive layer is increased by 18 μm, so that an entire copper thickness is 18+18=36 μm. The copper thickness is 36 μm that is the same as the copper thickness in the Comparative Embodiment, an impedance may remain unchanged, but an entire thickness may be reduced by 136−98.5=37.5 μm. In the Embodiment 1, to ensure that an appearance of the circuit board of the battery that is seen when the device is disassembled is still black, and improve beauty, a cover film on one side may be retained, and a cover film on the other side may be removed. Description of an impedance changelessness principle: A shape of the circuit board in the comparative embodiment is the same as a shape of the circuit board in this application. To facilitate calculation, a length L and a width W of the circuit board are used as an example to facilitate calculation and demonstration. A calculation formula for a trace impedance is R=ρL/S=ρL/(W/d), where ρ is resistivity of copper, is a fixed constant, and is 0.0175 Ωmm²/m, L is a trace length, W is a trace width, and d is a copper thickness. In the comparative embodiment, an impedance of the second area part R1=ρL/(W×d)×(½)=ρL/(W×18)×(½)=ρL/36 W In the Embodiment 1, an impedance of the second area part R2=ρL/(W×d)=ρL/(W×(18+18))=ρL/36 W It may be learned that R1=R2, that is, an original impedance effect remains unchanged, but the thickness is greatly reduced.

As shown in FIG. 1 and FIG. 3, thicknesses of layers in Comparative embodiment 2 and Embodiment 2 are shown in the following Table 2. Both the conductive layer and the base layer are copper layers.

TABLE 2
Thicknesses of layers on the substrate

| | Comparative | Embodi- | | Comparative | Embodi- |
|---|---|---|---|---|---|
| | embodiment | ment | | embodiment | ment |
| Name | 2 | 2 | Name | 2 | 2 |
| First area | Thickness/ | Thick- | Second | Thickness/ | Thickness/ |
| part | μm | ness/μm | area part | μm | μm |
| First cover | 12.5 | 12.5 | Second | 12.5 | 12.5 |
| film | | | cover film | | |
| First | 35 | 50 | Second | 35 | 50 |
| adhesive | | | adhesive | | |
| layer | | | layer | | |
| First | 25 | 20 | Second | 10 | 20 |
| conductive | | | conductive | | |
| layer | | | layer | | |
| First base | 25 | 50 | Second | 25 | 50 |
| layer | | | base layer | | |
| Substrate | 25 | 25 | Substrate | 25 | 25 |
| First base | 25 | 50 | Second | 25 | 0 |
| layer | | | base layer | | |
| First | 25 | 20 | Second | 10 | 0 |
| conductive | | | conductive | | |
| layer | | | layer | | |
| First | 35 | 50 | Second | 35 | 0 |
| adhesive | | | adhesive | | |
| layer | | | layer | | |
| First cover | 12.5 | 12.5 | Second | 12.5 | 0 |
| film | | | cover film | | |
| Total | 220 | 290 | Total | 190 | 157.5 |
| thickness | | | thickness | | |
| Copper | 110 | 140 | Copper | 70 | 70 |
| thickness | | | thickness | | |

In Comparative embodiment 2, the total thickness of the second area part is 190 μm, and the copper thickness is 70 μm. In Embodiment 2, a single-side film layer is used for the second area part, and the total thickness of the second area part is 157.5 μm, and the copper thickness is still 70 μm. The copper thickness remains unchanged, that is, an impedance remains unchanged, but a thickness may be reduced by 190 μm-157.5 μm=32.5 μm. To ensure that the copper thickness of the second area part is still 70 μm (the second base layer 50 μm+the second conductive layer 20 μm), a copper thickness of the first area part may be changed from 25 μm to 50 μm, a thickness of the adhesive layer may be changed from 35 μm to 50 μm, and a thickness of the entire area may be increased from 220 μm to 290 μm. During application, because the area part may be in a sink position without a thickness bottleneck, increase of the thickness does not affect an overall thickness of the device.

Description of an impedance changelessness principle: A shape of the circuit board in Comparative embodiment 2 is the same as a shape of the circuit board in Embodiment 2, To facilitate calculation, a length L and a width W of the circuit board are used as an example to facilitate calculation and demonstration. A calculation formula for a trace impedance is R=ρL/S=ρL/(W×d), where ρ is resistivity of copper, is a fixed constant, and is 0.0175 Ωmm²/m, L is a trace length, W is a trace width, and d is a copper thickness. In Comparative embodiment 2, an impedance of the second area part R1=ρL/(W×d)×(1/2)=ρL/(W×(10+25))×(1/2)=ρL/70 W. In Embodiment 2, an impedance of the second area part R2=ρL/(W×d)=ρL/(W×(20+50))=ρL/70 W. It may be learned that R1=R2, that is, an original impedance effect remains unchanged, but the thickness is greatly reduced.

The embodiments of this application are described with reference to the accompanying drawings. However, this application is not limited to the foregoing implementations. The foregoing implementations are merely examples, but are not limiting. Under the enlightenment of this application, a person of ordinary skill in the art max make many forms without departing from the objective and the scope of the claims of this application, and these forms all fall within the protection scope of this application.

1. A battery-connected circuit board, comprising:
a substrate, wherein the substrate is an insulator, the substrate comprises a first area part and a second area part, first conductive layers are disposed on surfaces on both sides of the first area part, a second conductive layer is disposed on a surface on one side of the second area part, and the second conductive layer is electrically connected to one of the first conductive layers that is on a same side as the second conductive layer.

2. The battery-connected circuit board according to claim 1, wherein a first cover film is disposed on one side, away from the substrate, of each of the first conductive layers, a second cover film is disposed on one side, away from the substrate, of the second conductive layer, and the first cover film and the second cover film are insulating material films.

3. The battery-connected circuit board according to claim 1, wherein the first area part is provided with a through hole, a conductive connector is disposed in the through hole, and the conductive connector is separately connected to the first conductive layers on the surfaces on both sides of the first area part.

4. The battery-connected circuit board according to claim 1, wherein a first base layer is disposed between the substrate and the first conductive layers, and the first base layer is a conductive material layer; and
a second base layer is disposed between the substrate and the second conductive layer, and the second base layer is a conductive material layer.

5. The battery-connected circuit board according to claim 4, wherein materials or thicknesses of the first base layer and the second base layer are the same.

6. The battery-connected circuit board according to claim 1, wherein materials or thicknesses of the first conductive layers and the second conductive layer are the same;
the first conductive layers and the second conductive layer are metal material layers; or
the battery-connected circuit board is a flexible circuit board.

7. A battery assembly, comprising:
a battery-connected circuit board comprising a substrate, wherein the substrate is an insulator, the substrate comprises a first area part and a second area part, first conductive layers are disposed on surfaces on both sides of the first area part, a second conductive layer is disposed on a surface on one side of the second area part, and the second conductive layer is electrically connected to one of the first conductive layers that is on a same side as the second conductive layer; and
a cell structure, wherein an edge of the cell structure is provided with a sink, one of the first conductive layers close to the cell structure is located in the sink, a surface on the other side of the second area part of the substrate abuts against a surface on one side of the cell structure, and the first conductive layers on surfaces on both sides of the first area part are both electrically connected to a charging electrode of the cell structure.

8. The battery assembly according to claim 7, further comprising:
a motherboard, wherein the cell structure is disposed on one side of the motherboard, and the battery-connected circuit board is disposed on one side, away from the motherboard, of the cell structure.

9. The battery assembly according to claim 8, further comprising:
a charging board, wherein the charging board is disposed on the motherboard, the charging board is electrically connected to the motherboard, and the charging board is electrically connected to the charging electrode of the cell structure.

10. The battery assembly according to claim 9, wherein a first connection part and a second connection part are disposed on the motherboard, the cell structure is disposed between the first connection part and the second connection part, the second conductive layer is electrically connected to the first connection part, one end of the charging hoard is electrically connected to the charging electrode of the cell structure, and the other end of the charging board is electrically connected to the second connection part.

11. An electronic device, comprising a battery assembly, wherein the battery assembly comprises:
a battery-connected circuit board comprising a substrate, wherein the substrate is an insulator, the substrate comprises a first area part and a second area part, first conductive layers are disposed on surfaces on both sides of the first area part, a second conductive layer is disposed on a surface on one side of the second area part, and the second conductive layer is electrically connected to one of the first conductive layers that is on a same side as the second conductive layer; and
a cell structure, wherein an edge of the cell structure is provided with a sink, one of the first conductive layers close to the cell structure is located in the sink, a surface on the other side of the second area part of the substrate abuts against a surface on one side of the cell structure, and the first conductive layers on surfaces on both sides of the first area part are both electrically connected to a charging electrode of the cell structure.

12. The electronic device according to claim 11, wherein the battery assembly further comprises:
a motherboard, wherein the cell structure is disposed on one side of the motherboard, and the battery-connected circuit board is disposed on one side, away from the motherboard, of the cell structure.

13. The electronic device according to claim 12, wherein the battery assembly further comprises:
a charging board, wherein the charging board is disposed on the motherboard, the charging board is electrically connected to the motherboard, and the charging board is electrically connected to the charging electrode of the cell structure.

14. The electronic device according to claim 13, wherein a first connection part and a second connection part are disposed on the motherboard, the cell structure is disposed between the first connection part and the second connection part, the second conductive layer is electrically connected to the first connection part, one end of the charging board is electrically connected to the charging electrode of the cell structure, and the other end of the charging board is electrically connected to the second connection part.
